(19) United States
(12) Patent Application Publication
(10) Pub. No.: US 2024/0175508 A1
(43) Pub. Date: May 30, 2024

(54) CASING OF VALVE CORE

(71) Applicant: CHUAN WEI METAL CO., LTD., CHANGHUA COUNTY (TW)

(72) Inventor: Chi-Chuan CHEN, CHANGHUA COUNTY (TW)

(21) Appl. No.: 17/994,861

(22) Filed: Nov. 28, 2022

(51) Int. Cl. F16K 27/04; F16K 11/00

(52) U.S. Cl. CPC F16K 27/044; F16K 19/006

(57) ABSTRACT

A valve core is accommodated in a cavity of a body of a faucet. A casing of the valve core contains a shoulder extending outward from the casing, and a diameter of the shoulder is equal to a diameter of a cavity of the body so that the valve core is engaged in the cavity by using the shoulder. The casing further contains: two engagement projections corresponding to two cutouts on a top of the cavity, two retaining teeth extending on the two engagement projections, such that when the valve core is received in the cavity, the two retaining teeth and the engagement projections are engaged in the two cutouts of the cavity so that the valve core is connected with the body, and the screw nut is screwed with a threaded section of the cavity to force the shoulder, thus connecting the valve core with the body.

### FIELD OF THE INVENTION

The present invention relates to a casing of a valve core which is configured to connect the valve core and a body of a faucet quickly and easily when the casing is received in a cavity of the body, and the valve core and the body are further fixed securely by using a screw nut.

### BACKGROUND OF THE INVENTION

A conventional faucet contains a body and a cavity defined in the body and configured to accommodate a valve core, and the valve core is configured to supply and stop water and to adjust a water supply. To supply water, the cavity is in communication with an inlet of a water inflow tube and an outlet of a water outflow tube, and the valve core has an inlet and an outlet. When the valve core is received in the cavity of the body, the valve core corresponds to the inlet of the water inflow tube and the outlet of the water outflow tube, thus supplying and stopping the water.

To connect the valve core in the body of the faucet, the valve core has two protrusions formed on a bottom thereof, and the cavity of the body has two recesses formed on a bottom thereof so that the two protrusions of the valve core are aligned with and received in the two recesses of the cavity, thus connecting the valve core with the cavity securely and supplying and stopping the water efficiently.

However, the fixing structure is formed on the bottoms of the valve core and the cavity, so it is not viewable to confirm the valve core is fixed in the cavity exactly. When the valve core is not fixed in the cavity exactly, it is removed and is received in the cavity repeatedly to cause troublesome connection.

To overcome such a problem, a fixing structure of a valve core has been developed, and the fixing structure contains two inverted-concave protrusions formed on a periphery of a top of the cavity of a body so that when the valve core is received in the cavity, the two inverted-concave protrusions of the valve core are engaged in the two cutouts. It is viewable to confirm the valve core is fixed in the cavity of the body of the faucet exactly.

Nevertheless, the valve core has to be replaced after a period of using time, and it is difficult to remove the two inverted-concave protrusions from the two cutouts, thus limiting a replacement of the valve core. Furthermore, the valve cannot be rotated by engaging the two inverted-concave protrusions in the two cutouts after being received in the cavity, and a screw nut outside the cavity cannot secure the valve core in the cavity firmly, so the valve core moves to cause a water leakage.

The present invention has arisen to mitigate and/or obviate the afore-described disadvantages.

### SUMMARY OF THE INVENTION

The primary object of the present invention is to provide a casing of a valve core which contains a shoulder formed on a top of the casing, such that when the valve core is received in the body of the faucet, the valve core is connected with the body, and the casing further contains two engagement projections extending downward from two predetermined positions of a bottom of the shoulder and corresponding to two cutouts on a top of the cavity of the body, two retaining teeth extending on two bottoms of the two engagement projections, two tilted guide corners formed on an inner wall and an outer wall of a respective one retaining tooth, such that when the valve core is received in the cavity of the body, the valve core is guided by the two tilted guide corners of the respective one retaining tooth to engage in the two cutouts of the cavity, and a screw nut is screwed with a threaded section of the cavity to force the shoulder of the valve core, thus connecting the valve core with the body.

Thereby, when the valve core is received in the cavity of the body, the screw nut is screwed with the threaded section of the cavity to force the shoulder of the valve core, thus connecting the valve core with the body securely.

### BRIEF DESCRIPTION OF THE DRAWINGS

FIG. 1 is a perspective view showing the exploded components of a casing of a valve core according to a preferred embodiment of the present invention.

FIG. 2 is a perspective view showing the exploded components of a part of the casing of the valve core according to the preferred embodiment of the present invention.

FIG. 3 is another perspective view showing the exploded components of a part of the casing of the valve core according to the preferred embodiment of the present invention.

FIG. 4 is a cross sectional view showing the assembly of a part of the casing of the valve core according to the preferred embodiment of the present invention.

### DETAILED DESCRIPTION OF THE PREFERRED EMBODIMENTS

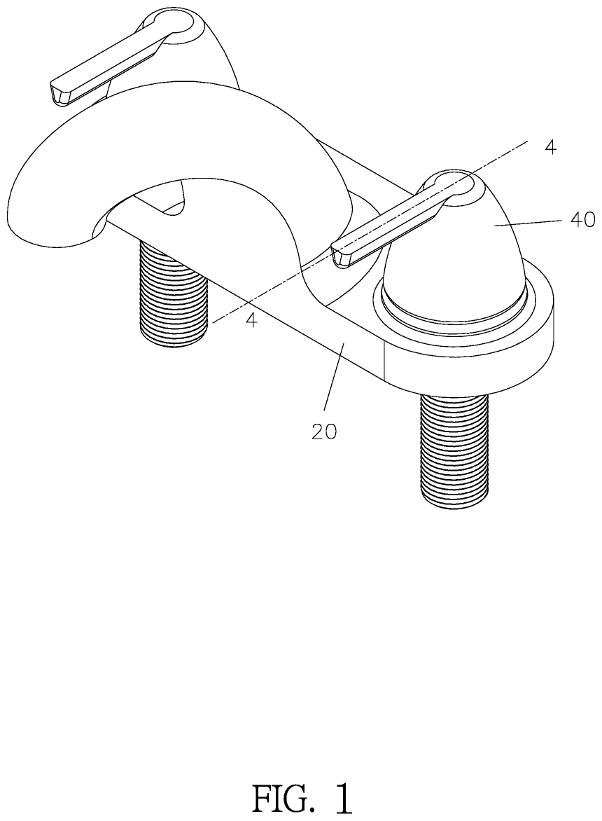

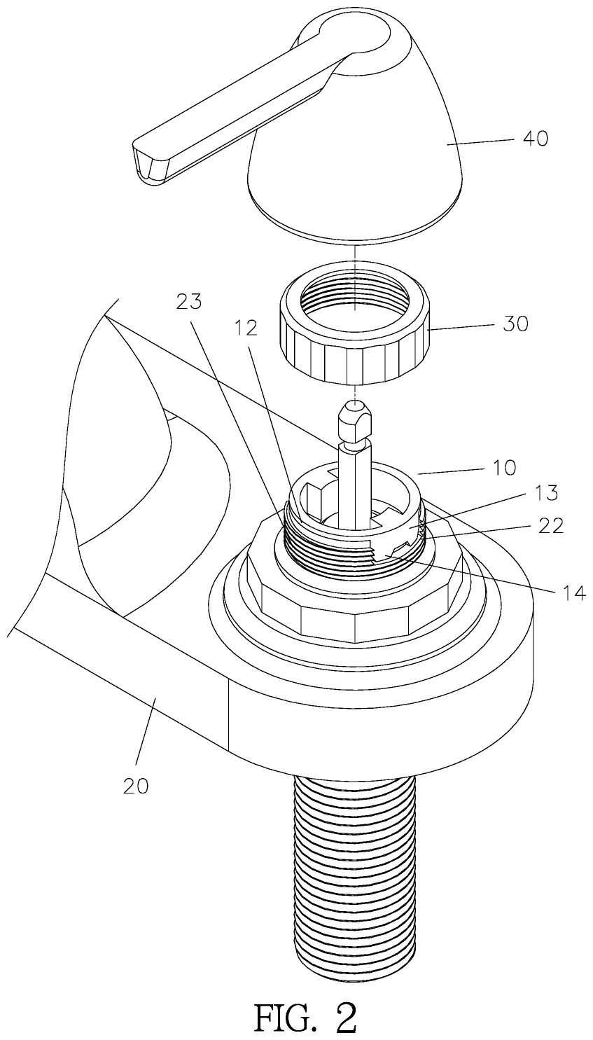

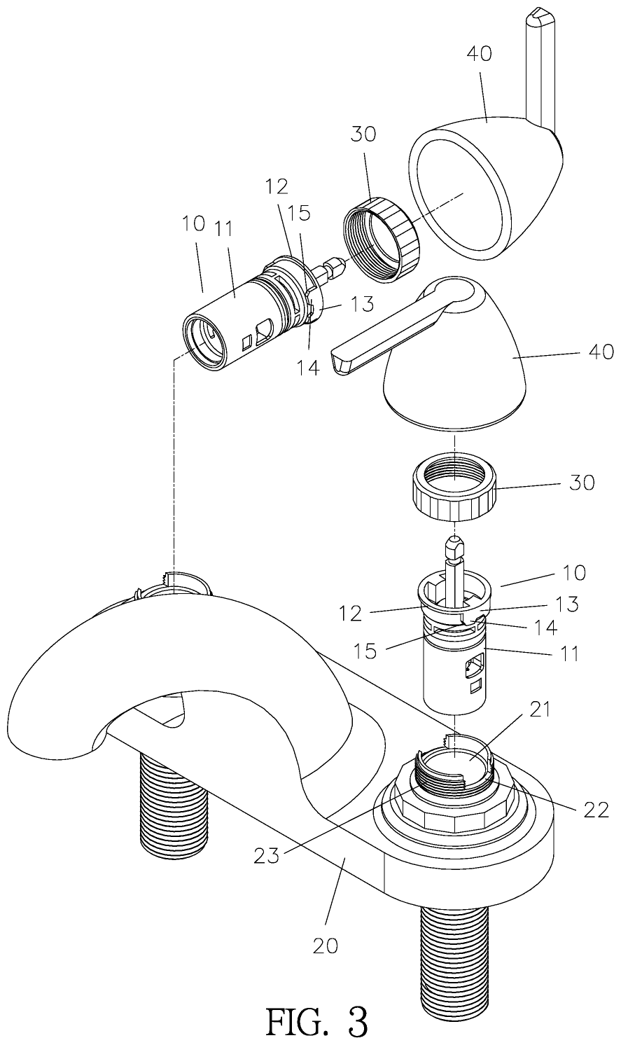

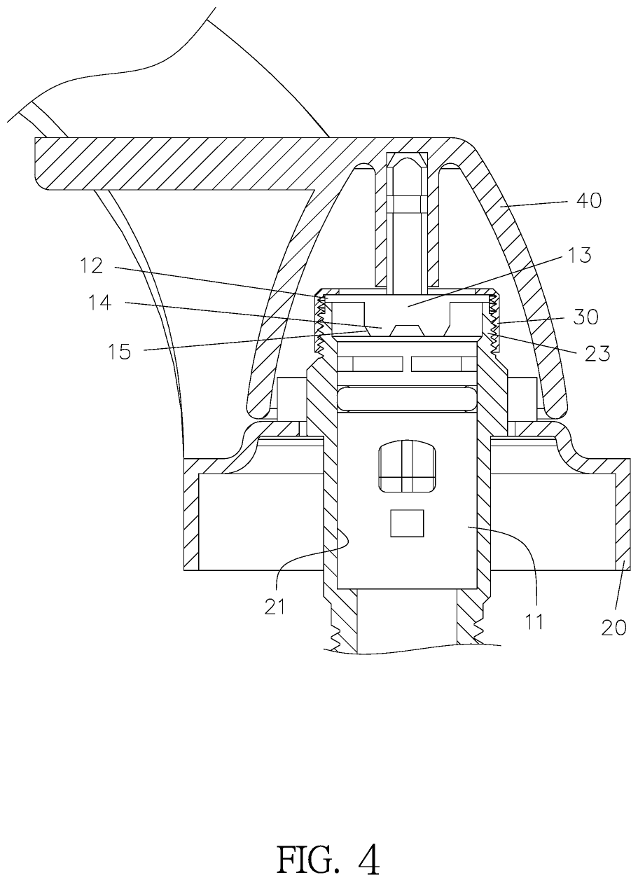

With reference to FIGS. 1-4, a casing of a valve core according to a preferred embodiment of the present invention is configured to connect the valve core 10 and a body 20 of a faucet quickly and easily. The casing 11 of the valve core 10 comprises a shoulder 12 extending outward from a periphery of a top of the casing 11, wherein a diameter of the shoulder 12 is equal to a diameter of a cavity 21 of the body 20 so that the valve core 10 is engaged in the cavity 21 of the body 20 by using the shoulder 12, and the casing 11 further comprises two engagement projections 13 extending downward from two predetermined positions of a bottom of the shoulder 12 and corresponding to two cutouts 22 on a top of the cavity 21 of the body 20, two retaining teeth 14 extending on two bottoms of the two engagement projections 13, and two tilted guide corners 15 formed on an inner wall and an outer wall of a respective one retaining tooth 14, such that when the valve core 10 is received in the cavity 21 of the body 20, the valve core 10 is guided by the two tilted guide corners 15 of the respective one retaining tooth 14 to engage in the two cutouts 22 of the cavity 21, and a screw nut 30 is screwed with a threaded section 23 of the cavity 21 to force the shoulder 12 of the valve core 10, thus connecting the valve core 10 with the body 20, and a decoration cap 40 is fitted on the valve core 10, thus connecting a faucet.

Thereby, the two retaining teeth 14 extend on the two bottoms of the two engagement projections 13 of the shoulder 12 and are configured to be engaged in the two cutouts 22 of the cavity 21. In another embodiment, the valve core includes two inverted-concave protrusions formed on a periphery of a top thereof to correspond to two cutouts on a top of the cavity of the body. In other words, the casing 11 of the valve core 10 is applicable for different types of valve cores 10 of the body 20, and the screw nut 30 is screwed with the threaded section 23 of the cavity 21 to force the shoulder 12 of the valve core 10 to be engaged in the cavity 21 of the body 20, thus connecting the valve core 10 with the body 20 securely.

Accordingly, the casing is configured to connect the valve core easily, and the screw nut is screwed with the threaded section of the cavity to force the shoulder of the valve core to be engaged in the cavity of the body securely.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A casing of a valve core, the valve core being accommodated in a cavity of a body of a faucet, and the valve core being fixed by a screw nut which is screwed with a threaded section of the body, the casing comprising:
a shoulder extending outward from a periphery of a top distal end of the casing, wherein a diameter of the shoulder is equal to a diameter of the threaded section so that the valve core is engaged in the cavity of the body by using the shoulder, and the casing further comprises two engagement projections respectively extending downward from two predetermined positions of a bottom of the shoulder and corresponding to two cutouts on a top of the threaded section, two retaining teeth extending on a bottom of each engagement projection, such that when the valve core is received in the cavity of the body, the engagement projections are engaged in the two cutouts, respectively, so that the valve core is connected with the body, and the screw nut is screwed with the threaded section to force the shoulder of the valve core, thus connecting the valve core with the body,
wherein two tilted guide corners are formed on an inner wall and an outer wall of a respective one retaining tooth, such that when the valve core is received in the cavity, the valve core is guided by the two tilted guide corners of the respective one retaining tooth engaged in a respective cutout.

2. (canceled)
